(19) United States
(12) Patent Application Publication
(10) Pub. No.: US 2014/0278133 A1
(43) Pub. Date: Sep. 18, 2014

(54) SYSTEMS AND METHODS FOR DISEASE ASSOCIATED HUMAN GENOMIC VARIANT ANALYSIS AND REPORTING

(71) Applicant: Advanced Throughput, Inc., Moraga, CA (US)

(72) Inventors: Fanqing Chen, Moraga, CA (US); Han Wu, Albany, CA (US)

(73) Assignee: Advanced Throughput, Inc., Moraga, CA (US)

(21) Appl. No.: 14/161,981

(22) Filed: Jan. 23, 2014

Related U.S. Application Data
(60) Provisional application No. 61/792,522, filed on Mar. 15, 2013.

(51) Int. Cl. G06F 19/18

(52) U.S. Cl. CPC G06F 19/18
USPC 702/19

(57) ABSTRACT

Systems and methods for disease associated human genomic variant analysis and reporting is disclosed. The systems and methods include receiving and extracting disease related variant information; storing the disease related variant information in a first data structure. Moreover, the system and methods include identifying a plurality of genomic variants and determining one or more probability of disease associated with at least one or more of the plurality of genomic variants. For at least one or more of the plurality of genomic variants that has at least one probability of disease that is greater than a threshold, the systems and methods may also obtain validation of the at least one of the plurality of genomic variants using the validation module. A report may be created to include at least a disease and the likelihood of the disease.

### LIMITED COPYRIGHT AUTHORIZATION

A portion of disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### BACKGROUND

### Description of the Related Art

Computational analysis of genomic sequencing results, including genomic variants, can be used to predict likelihood of disease.

### SUMMARY

A computer system according to some aspects of the disclosure may include one or more computer processors, and a tangible storage device storing a variant analysis module, one or more statistics modules for disease risk prediction, a validation module and a reporting module. The modules can be configured for execution by the one or more computer processors. The modules can be configured to receive and extract disease related variant information. The modules can also be configured to store the disease related variant information in a first data structure. For each of a plurality of genomic sequences associated with a person, a plurality of genomic variants may be identified via the variant analysis module. A plurality of the plurality of genomic variants can be stored in a second data structure. One or more probability of disease associated with at least one or more of the plurality of genomic variants may be determined via the at least one of the one or more statistics modules and the disease related variant information stored in the first data structure. For at least one or more of the plurality of genomic variants that has at least one probability of disease that is greater than a threshold, validation may be obtained for the at least one of the plurality of genomic variants using the validation module. In response to determining that validation of the at least one of the plurality of genomic variants is obtained, a report can be created via the reporting module. The report may include, at least, a disease and the likelihood of the disease. The likelihood of disease may be determined based at least in part on the one or more statistics modules and the disease related variant information stored in the first data structure.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a flow chart illustrating one embodiment of a data flow in an illustrative operating environment for genomic sequencing and alignment.

FIG. 2 is a flowchart that illustrates one embodiment of the sequence processing step after genomic sequencing results are received.

FIG. 3 is a system diagram and flowchart that illustrates one embodiment of a process of database query, variant analysis, statistical prediction of likelihood of disease, validation, and customized reporting.

FIG. 4 is an illustrative user interface that may be generated and presented to a user to allow the user to generate customized variant analysis and disease likelihood reports including information regarding validation of such analysis and/or reports.

FIG. 5 is a block diagram illustrating one embodiment of a system for calculating and presenting genomic sequence variant analysis data and disease likelihood data.

FIG. 6A is an embodiment of a clinical report which may include information such as disease risk, carrier status, traits, and/or drug response.

FIG. 6B is an embodiment of a report including information such as variant, disease association, likelihood of disease and affected gene.

FIG. 6C is an embodiment of a user interface that may be generated and presented to a user to show specific disease risks associated with one or more genomic variants.

FIG. 6D is an embodiment of details related to a genomic variant of a patient.

FIG. 7 is an embodiment of an interface illustrating ancestry-related information that may be relevant to diseases.

FIG. 8 is an embodiment of a report visualizing a genomic sequencing variant file related to genomic sequence data of a patient.

FIG. 9A is an embodiment of a disease prediction report template that may be generated and presented to a user with warnings of a probability of disease, which may include a bar chart representation of mutations and associated disease risk.

FIG. 9B is an embodiment of a disease prediction report template that may be generated and presented to a user to indicate risk of disease, which may include a scatterplot representation of genotype data and associated disease risks.

### DETAILED DESCRIPTION

Various embodiments of systems, methods, processes, and data structures will now be described with reference to the drawings. Variations to the systems, methods, processes, and data structures which represent other embodiments will also be described. Certain aspects, advantages, and novel features of the systems, methods, processes, and data structures are described herein. It is to be understood that not necessarily all such advantages may be achieved in accordance with any particular embodiment. Accordingly, the systems, methods, processes, and/or data structures may be embodied or carried out in a manner that achieves one advantage or group of advantages as taught herein without necessarily achieving other advantages as may be taught or suggested herein.

Genomic sequencing data may be aligned so that variants in the genomic sequences of an individual may be detected by comparing the genomic sequences of an individual to one or more reference sequences. Statistical and/or machine learning methods may be applied to predict a likelihood of disease based on genomic variant information and information regarding the possible association between genomic variants and diseases.

Disclosed herein are systems and methods for genomic variant analysis, disease likelihood prediction, analysis and prediction validation, and customized report generation. Such systems and methods may be used to make high-confidence variant-based likelihood of disease analysis and predictions to clinicians, researchers, and/or patients.

### Example Genomic Sequencing and Alignment Process

FIG. 1 is a flow chart illustrating one embodiment of a data flow in an illustrative operating environment for genomic sequencing and alignment. As illustrated in FIG. 1, DNA samples may be obtained from a plurality of patients 110. In some embodiments, DNA samples of more than 90 patients may be obtained and processed in batch at a time. In some embodiments, DNA samples may be obtained from fetus. Depending on the embodiment, the method of FIG. 1 may include fewer or additional blocks and blocks may be performed in an order that is different than illustrated.

Depending on the embodiments, the obtained DNA samples may be amplified through techniques such as Multiple Displacement Amplification (“MDA”). The MDA amplification technique can rapidly amplify the obtained DNA samples to a reasonable quantity sufficient for genomic analysis. Compared to conventional PCR amplification technique, MDA generates larger sized products with typically lower error frequencies.

In some embodiments, the MDA process involves steps such as sample preparation, condition, end of reaction, and purification of DNA products. After the completion of the MDA amplification process, amplified DNA samples 120 may be obtained.

According to some embodiments of the disclosure, the amplified DNA samples may undergo a library construction process. During the library construction process, tubes containing the amplified DNA samples 120 may be labeled with bar codes. For example, if there are a total of 96 amplified DNA samples, tubes containing the amplified DNA samples 120 may be labeled with bar code 1 through bar code 96. A library 130 of the amplified DNA samples 120 may thus be constructed. In some embodiments, the bar codes of the samples may contain additional relevant information.

In some embodiments, the amplified DNA samples 120, as a library 130, may undergo a sequencing process. In some embodiments, sequencers such as the Ion Proton™ system may be used for sequencing. In some other embodiments, other state-of-the-art sequencing systems may be used for sequencing purposes.

In some embodiments, in order to ensure quality and depth of sequencing coverage, each sample in the library 130 may be sequenced to certain sequencing depth to result in a 20× to 50× coverage. In some embodiments, more coverage or less coverage may be implemented in the sequencing process. The purpose of creating more coverage for each sample sequenced is to ensure that the genomic variants detected may be real genomic variants instead of sequencing artifacts.

After sequencing, raw data 140 may be obtained. In some embodiments, raw data 140 may undergo a de-coding process. Depending on embodiments, the de-coding process may involve reading the bar codes generated previously and annotate the raw data 140 in such a way that the raw data associated with respective individuals/fetuses may be identified.

In some embodiments, the patient sequences 150 may undergo a sequence processing step before becoming alignment data files 180. Depending on the embodiments, the processing step may involve Quality Control (“QC”), filtering, and alignment. After processing, aligned sequence data 170 may be obtained. In some embodiments, one or more reference genomes may be used for the purpose of alignment. In some embodiments, a reference genome that may be used for alignment is the human genome (hg19, GRCh37). In some other embodiments, other reference genomes may also be used for alignment. After sequence data alignment, the aligned sequence data 170 may undergo post-alignment cleanup and become alignment data files 180. In some embodiments, the alignment data files may be in a format of BAM or SAM files. In some other embodiments, the alignment data files 180 may be in a different format.

Details of the processing steps may be better understood in conjunction with FIG. 2. FIG. 2 is a flowchart that illustrates one embodiment of the sequence processing step after genomic sequencing results are received. The method of FIG. 2 may be performed by a sequence processing module 530. Depending on the embodiment, the method of FIG. 2 may include fewer or additional blocks and blocks may be performed in an order that is different than illustrated.

The method 200 begins at block 210. The method 200 proceeds to block 215, where the sequence processing module 530 may perform quality control (“QC”) on the received patient sequences 150. As discussed above, patient sequences 150 may also include fetus sequences.

In some embodiments, the QC performed in block 215 may include checking to see whether desired sequence depth is reached; whether there is potential sample mix-up; and whether the overall sequencing quality is good, and so forth. In some embodiments, the overall sequencing quality may be determined based on Phred Quality Scores (also referred to as “Q20”). Phred is a base-calling program for DNA sequence traces. Phred base-specific quality scores may range from 4 to about 60, with higher values corresponding in general to higher quality of sequencing reads. In some embodiments, the quality scores may be logarithmically linked to error probabilities. In some embodiments, a Phred Quality Score (Q20) of larger than or equal to 100b may be sufficient to pass the sequencing quality requirement of the QC step. In other embodiments, a higher or lower threshold may be customized and adopted.

The method 200 proceeds to decision block 220, where it is determined whether the received patient sequences 150 pass the QC check successfully. If the answer to the decision block 220 is no, in some embodiments, the portion of the received patient sequences 150 that do not pass the QC checks may not be further processed. Further steps in such cases may include re-sequencing and/or investigating the sources of low quality sequence data. In some other embodiments, different approaches may be taken for sequencing data that do not pass the QC checks.

If the answer to the decision block 220 is yes, the method 200 proceeds to block 225, where filtering is performed on the QC-checked patient sequences. Depending on embodiments, filtering may remove sequencing adapters, common contaminants such as dyes, low complexity reads, and/or sequencing platform specific artifacts.

The method 200 then proceeds to block 230, where the QC-checked and filtered patient sequences may be aligned to one or more reference genomes. As discussed previously, in some embodiments, the hg19, GRCh37 reference human genome may be used. In other embodiments, one or more other reference genomes may also be used. In some embodiments, the sequence processing module 530 or another module may be configured to automatically search for updates to reference genome information and update the reference genome used for genomic sequencing analysis and alignment.

The method 200 proceeds to block 235, where post-alignment cleanup is performed. In some embodiments, the post-alignment cleanup process may involve removing PCR duplicates, adjusting base quality values. In some embodiments, the post-alignment cleanup process may be performed by the GATK software package. The method 200 then ends at block 240.

### Example Variant Analysis and Likelihood of Disease Prediction Processes

FIG. 3 is a system diagram and flowchart that illustrates one embodiment of a process of database query, variant analysis, statistical prediction of likelihood of disease, validation, and customized reporting. In FIG. 3, the method 300 involves constructing one or more disease/variant data structures 310. The disease/variant data structures 310 may include extracting information related to disease-related genomic variants from a plurality of databases 305. Existing databases of disease-genomic variant associations may contain irrelevant and low-quality data. Therefore, removing the low-quality data and irrelevant information from information received from the plurality of databases 305 may be included in the construction of the one or more disease/variant data structures 310.

In some embodiments, information may be extracted from databases such as the OMIM (Online Mendelian Inheritance in Man) database, dbSNP, 1000Genomes, and so forth. In some embodiments, relevant disease-genomic variant association information may also be extracted from research literature and included in the one or more disease/variant data structures 310. Depending on embodiments, the disease/variant data structures 310 may be set up to be automatically updated when new releases are available for the plurality of databases 305.

In some embodiments, the disease/variant data structures 310 may include not only the genomic location and details about the genomic variants, but also include the type(s) of each variant. For example, types of variant may include short insertions/deletions (INDEL), structure variants (SV), copy number variants (CNV), single nucleotide substitutions (SNV/SNP), and so forth. In some embodiments, a single genomic variant may fall into more than one type of variants. For example, a large deletion may also be defined as a CNV.

In some embodiments, the disease/variant data structure 310 may classify the disease involved into two or more categories. In some embodiments, disease may be categorized into rare diseases and common diseases. Depending on embodiments, rare diseases may include diseases such as Asperger syndrome/disorder, Bowen's disease, Paranelplastic pemphigus, and so forth. A list of rare disease may be obtained from the website of the National Institute of Health (NIH). Depending on embodiments, common diseases may include acne, allergy, flu, cold, altitude sickness, arthritis, back pain, and so forth.

The variant analysis module 320 may receive alignment data files 180, and perform variant analysis using the alignment data files 180. For example, the variant analysis module 320 may use software packages that convert BAM/SAM files into VCF files and/or other files. The variant analysis module 320 may also perform other variant-calling functions that identify the genomic location of variants, and so forth.

In some embodiments, after the variant analysis 320 finishes processing an alignment data file, the detected variants may be stored in a patient variant data structure 360. In some embodiments, the detected variants may be stored in the patient variant data structure 360 together with annotations based on information extracted by the variant analysis module 320 from the disease/variant data structures 302.

After variants are detected by the variant analysis module 320, they may be used by the statistics module for rare diseases 325 and the statistics module for common diseases 330 to determine the likelihood for common diseases, likelihood for rare disease and/or sequencing artifacts.

In some embodiments, the statistics module for common diseases 330 may use a statistical analysis model such as the Fisher's Exact Test to study the likelihood of common diseases. Depending on the embodiments, other statistical analysis tools may also be used. Moreover, in some embodiments, different statistical analysis tools may be employed for different types of common diseases. In some other embodiments, machine learning techniques such as decision tree, Naïve Bayes algorithm, kernel methods, and/or support vector machine may also be used by the statistics module for common diseases 330.

In some embodiments, the statistics module for common disease 330 may generate a numerical value that may be used to represent a patient's likelihood of developing a common disease. In some embodiments, a cut-off value may be determined and applied to the likelihood of developing a common disease such that common diseases with likelihoods below the cut-off value may not be further reported to the reporting module 345. In some embodiments, more than one cut-off values may be determined and applied for different types of common diseases. In some embodiments, the cut-off value is selected to be stringent so that only common diseases that are highly likely to occur may be reported to the reporting module 345.

In some embodiments, the statistics module for rare diseases 325 may use machine learning techniques such as decision tree, Naïve Bayes algorithm, kernel methods, and/or support vector machine to predict likelihood of rare diseases. In some embodiments, specific types of rare diseases may be associated with one or more specific machine learning techniques. Moreover, the statistics module for rare diseases 325 may also determine a likelihood of sequencing error. The likelihood value may determine the likelihood that a variant is a result of sequencing error instead of a real existing variant in a patient or fetus. In some embodiments, only diseases-related variants that pass the likelihood of sequencing error test may be reported further to the reporting module 345.

In some embodiments, the statistics module for rare disease 325 may generate a numerical value that may be used to represent a patient's likelihood of developing a rare disease. In some embodiments, a cut-off value may be determined and applied to the likelihood of developing a rare disease such that rare diseases with likelihoods below the cut-off value may not be further reported to the reporting module 345. In some embodiments, more than one cut-off values may be determined and applied for different types of rare diseases. In some embodiments, the cut-off value is selected to be stringent so that only rare diseases that are highly likely to occur may be reported to the reporting module 345.

The reporting module 345 may collect a list of rare and common diseases received from the respective statistics modules 325 and 330, respective likelihood of each disease, genomic variant information, and/or other relevant information, and verify that each disease and variant information received have passed the one or more cut-off value for disease likelihood and sequencing errors. The reporting module may then submit the initial list of rare and common disease-related variants to a validation step 350 for further verification.

In some embodiments, the validation step 350 may involve performing PCR and/or re-sequencing in order to verify that an identified variant that is predicted to cause one or more rare or common disease is not an artifact created by a sequencing error. In some other embodiments, other validation techniques may be used in order to accurately and inexpensively validate the existence of the identified variants.

At the completion of each validation step involving a variant, results of validation may be reported back to the reporting module 345. In some embodiments, the reporting module may create one or more customized report 360 based on the particular needs of the audience of the report. For example, if the audience of the report is a physician, the customized report 360 for the physician may include information such as: likelihood of rare/common diseases, which may be ranked by the likelihood value; variant information such as variant location, reference genomic sequence, variant genomic sequence, and so forth; results of validation; sequencing parameters; alignment parameters; and/or validation parameters. Additional information may also be included, which may be, for example, drug information, if any.

In some embodiments, if the audience of a report is a patient or relatives, friends, and/or families of a patient and/or a fetus, the customized report 360 may include information that is also included in the report for a physician. In addition, the customized report 360 may include information that may help interpret academic language and jargons about diseases and variants for patients and their families. Moreover, the customized report 360 may include translated articles, paragraphs, and/or other information to help patients and their families whose first language is not English to better understand scientific and technical details in the generated reports.

FIG. 4 is an illustrative user interface that may be generated and presented to a user to allow the user to generate customized variant analysis and disease likelihood reports including information regarding validation of such analysis and/or reports. In FIG. 4, the example user interface 400 may include a link 402 to sequencing and validation methods used. In some embodiments, the sequencing and validation methods 402 may also be displayed directly in the user interface 400.

The example user interface 400 may also include a list of top-ranked possible diseases based at least in part on the likelihood of disease. In some embodiments, a separate list of top-ranked possible diseases may be generated for common disease and rare diseases, respectively. In example user interface 400, for example, possible diseases 1-8 are listed (marked 404 through 420) with the option of selecting each, a subset, or all of the possible diseases to be displayed in a report.

FIG. 6A is an embodiment of a clinical report which may include information such as disease risk, carrier status, traits, and/or drug response. In FIG. 6A, a clinical report may be generated and presented to a doctor, a patient, a family member of a patient, and so forth. The example report 600 as shown may include information such as name of the patient, disease risks, carrier status, traits of the patient, and/or a link 620 for viewing sequencing data and variants associated with the genomic sequences.

In some embodiments, disease risks presented to a patient in a clinical report may also include a likelihood of disease, which may be represented as a numerical value or a chart.

Depending on the embodiment, each variant associated with a disease risk entry or a carrier status entry may be further explored by clicking on a link such as link 610. More details regarding each variant listed in the example report 600 may be generated and presented to a user automatically.

FIG. 6B is an embodiment of a report including information such as variant, disease association, likelihood of disease and affected gene. Depending on the embodiment, a report such as the example report 650 may include details about a particular variant. In this example, Variant 1 (labeled 615) is shown. It is of the type SNV (single nucleotide variant), which includes a mutation of G to C. The possibly associated disease is X disease, with a probability of disease of 99%. The host/nearby gene is Gene X.

FIG. 6C is an embodiment of a user interface that may be generated and presented to a user to show specific disease risks associated with one or more genomic variants. In this embodiment of FIG. 6C, a gene OGT (641) and a gene CXorf65 are shown. The genomic coordinates of each gene is also displayed. For example, the genomic coordinates of OGT is 70711329. In some embodiments, the dbSNP ID of each gene (e.g., 643) may also be displayed, together with allele information. In some embodiments, a chromosomal map view of a gene may be displayed. In the user interface 640, depending on the embodiment, a bar chart showing the number of risk alleles and the likelihood of disease risk (a percentage value) may also be generated and presented to a user, as shown in the example embodiment 645. In some other embodiments, other types of charts may be generated to display similar information. The other types of charts may include scatterplots, pie charts, and so forth.

FIG. 6D is an embodiment of details related to a particular genomic variant of a patient. In this particular example, more detailed information regarding a potentially disease-related variant may be explored. In the example user interface 650, a gene named OGT is identified. Information regarding the function of the protein coded by the gene OGT is provided, together with the gene's chromosome location, descriptions, and aliases. In some embodiments, external links may be provided in the user interface. For example, the user interface 650 may include links to the USCS Genome Browser, NCBI Gene, NCBI Protein, OMIM, Wikipedia, and so forth.

FIG. 7 is an embodiment of an interface 700 that may be generated and presented to a user illustrating ancestry-related information that may be relevant the user and his or her potential disease risks. For example, information regarding genetic distances between individuals may be displayed in a tree format as shown in the user interface 700. In some embodiments, if information regarding another individual's genetic variants and disease risks may be related is available, such information may be made available to the patient. Depending on the embodiment, a link to such information may be displayed to the patient in a tree format. Moreover, in some embodiments, a doctor may be able to view a tree format graph as shown in the user interface 700, and find common genetic variants and/or other ancestral and or social information among a group of related individuals.

FIG. 8 is an embodiment of a user interface providing a report visualizing a genomic sequencing variant file related to genomic sequence data of a patient. As shown in the example VCF file viewer 660, variants involved in each chromosome are highlighted. In some embodiments, the interface 800 may include clickable links in at least a portion of the displayed chromosomes, which would enable a user to follow the links and view specific sequence information.

FIG. 9A is an embodiment of a disease prediction user interface template that may be generated and presented to a user with warnings of a probability of disease, which may include a bar chart representation of mutations and associated disease risk. In the template 900, a bar chart may include an indicator of specific risk of disease 925, which indicates the relation between the disease risk percentage and the number of mutations. In some embodiments, the template 900 may also include relevant disease information retrieved from a disease/variant data structure 302, such as disease description, disease type (e.g., single gene disorder), a list of relevant disease-causing genes/mutations for which the prediction report is generated, and a list of mutations identified.

In some embodiments, the template 900 may also include a link 915 to a chromosome view of the disease prediction report. In some embodiments, the chromosome view of the disease prediction report may display the location of relevant variants with information regarding not only the variants, but the genomic environment surrounding the variant, including information such as the closest or affected genes. Depending on the embodiment, the template 900 may display a warning to a user about a particularly high chance of developing a disease, and advise a patient to seek expert help. In some embodiments, a list of experts 930 pertaining to a particular disease area may be generated and displayed to a user if a user wishes to see the list.

FIG. 9B is an embodiment of a disease prediction report template that may be generated and presented to a user to indicate risk of disease, which may include a scatterplot representation of genotype data and associated disease risks. In the template 950, a scatterplot 965 may include an indicator of specific risk of disease, which may indicate the relation between the disease risk percentage and the number of risk genotypes. In some embodiments, the template 950 may also include relevant disease information retrieved from a disease/variant data structure 302, such as disease description, disease type (e.g., single gene disorder), a list of relevant disease-causing genes/mutations for which the prediction report is generated, and a list of mutations identified.

In some embodiments, the template 950 may also include a link 915 to a chromosome view of the disease prediction report. In some embodiments, the chromosome view of the disease prediction report may display the location of relevant variants with information regarding not only the variants, but the genomic environment surrounding the variant, including information such as the closest or affected genes. Depending on the embodiment, the template 950 may display a warning to a user about a particularly high chance of developing a disease, and advise a patient to seek expert help. In some embodiments, a list of experts 960 pertaining to a particular disease area may be generated and displayed to a user if a user wishes to see the list.

### Example Computing System

FIG. 5 is a block diagram illustrating one embodiment of a system 510 for calculating and presenting genomic sequence variant analysis data and disease likelihood data.

In this embodiment of FIG. 5, the variant analysis module 514, statistics module 516, sequence processing module 530, and reporting module 526 are in contact with a mass storage device 512, which may store information related to genomic sequences, variants, and disease association information related to patients and fetuses.

In some embodiments, the reporting module 526 may also execute instructions that generate user interfaces that may be presented to consumers through I/O interfaces and devices 522. In some embodiments, the data stores in this disclosure may be implemented using a relational database, such as Sybase, Oracle, CodeBase and Microsoft® SQL Server as well as other types of data structures such as, for example, a flat file database, an entity-relationship database, and object-oriented database, a record-based database, and/or an unstructured database.

The computing system 510 may include, for example, a computer that may be IBM, Macintosh, or Linux/Unix compatible or a server or workstation. In one embodiment, the computing system 510 comprises a server, desktop computer, a tablet computer, or laptop computer, for example. In one embodiment, the exemplary computing system 510 includes one or more central processing units (“CPUs”) 920, which may each include a conventional or proprietary microprocessor. The computing system 510 further includes one or more memory 524, such as random access memory (“RAM”) for temporary storage of information, one or more read only memory (“ROM”) for permanent storage of information, and one or more mass storage device 512, such as a hard drive, diskette, solid state drive, or optical media storage device. Typically, the modules of the computing system 510 are connected to the computer using a standard based bus system 528. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of computing system 510 may be combined into fewer components and modules or further separated into additional components and modules.

The computing system 510 is generally controlled and coordinated by operating system software, such as Windows XP, Windows Vista, Windows 7, Windows 8, Windows Server, Unix, Linux, SunOS, Solaris, or other compatible operating systems. In Macintosh systems, the operating system may be any available operating system, such as MAC OS X. In other embodiments, the computing system 510 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 510 may include one or more commonly available input/output (I/O) devices and interfaces 522, such as a keyboard, mouse, touchpad, and printer. In one embodiment, the I/O devices and interfaces 522 include one or more display devices, such as a monitor, that allows the visual presentation of data to a user. More particularly, a display device provides for the presentation of GUIs, application software data, and multimedia presentations, for example. The computing system 510 may also include one or more multimedia devices, such as speakers, video cards, graphics accelerators, and microphones, for example.

In the embodiment of FIG. 5, the I/O devices and interfaces 522 provide a communication interface to various external devices. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 5, the computing system 510 is also configured to execute the variant analysis module 514, statistics module 516, sequence processing module 530, and reporting module 526 in order to implement functionality described elsewhere herein.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 510, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, one or more computing systems, data stores and/or modules described herein may be implemented using one or more open source projects or other existing platforms. For example, one or more computing systems, data stores and/or modules described herein may be implemented in part by leveraging technology associated with one or more of the following: Drools, Hibernate, JBoss, Kettle, Spring Framework, NoSQL (such as the database software implemented by MongoDB) and/or DB2 database software.

### Other Embodiments

Although the foregoing systems and methods have been described in terms of certain embodiments, other embodiments will be apparent to those of ordinary skill in the art from the disclosure herein. Additionally, other combinations, omissions, substitutions and modifications will be apparent to the skilled artisan in view of the disclosure herein. While some embodiments of the inventions have been described, these embodiments have been presented by way of example only, and are not intended to limit the scope of the inventions. Indeed, the novel methods and systems described herein may be embodied in a variety of other forms without departing from the spirit thereof. Further, the disclosure herein of any particular feature, aspect, method, property, characteristic, quality, attribute, element, or the like in connection with an embodiment can be used in all other embodiments set forth herein.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

What is claimed is:

1. A computer system comprising:
one or more computer processors;
a tangible storage device storing a variant analysis module, one or more statistics modules for disease risk prediction, a validation module, a reporting module, wherein the modules are configured for execution by the one or more computer processors to:
receive and extract disease related variant information;
store the disease related variant information in a first data structure;
for each of a plurality of genomic sequences associated with a person, identify a plurality of genomic variants via the variant analysis module;
store the plurality of genomic variants in a second data structure;
determine one or more probability of disease associated with at least one or more of the plurality of genomic variants via the at least one of the one or more statistics modules and the disease related variant information stored in the first data structure,
for at least one or more of the plurality of genomic variants that has at least one probability of disease that is greater than a threshold, obtain validation of the at least one of the plurality of genomic variants using the validation module;
in response to determining that validation of the at least one of the plurality of genomic variants is obtained, create a report via the reporting module, wherein the report comprises at least:
a disease and the likelihood of the disease, wherein the likelihood of disease is determined based at least in part on the one or more statistics modules and the disease related variant information stored in the first data structure.

2. The computer system of claim 1, wherein the computer system is further configured to:
receive updated disease-related variant information;
in response to receiving updated disease-related variant information, automatically update the first data structure.

3. The computer system of claim 1, wherein the one or more statistics modules comprises a rare disease statistics module and a common disease statistics module.

4. The computer system of claim 3, wherein the rare disease statistics module is configured to apply a Fisher's exact test to calculate a likelihood of rare disease based on at least a variant.

5. The computer system of claim 3, wherein the rare disease statistics module is configured to determine a likelihood of sequencing error.

6. The computer system of claim 3, wherein the common disease statistics module is configured to apply a Fisher's exact test to calculate a likelihood of common disease based on at least a variant.

7. The computer system of claim 1, wherein the report further comprises whether a variant is validated.

8. A non-transitory computer-readable storage medium comprising computer-executable instructions that direct a computing system to:
receive and extract disease related variant information;
store the disease related variant information in a first data structure;
for each of a plurality of genomic sequences associated with a person, identify a plurality of genomic variants via the variant analysis module;
store the plurality of genomic variants in a second data structure;
determine one or more probability of disease associated with at least one or more of the plurality of genomic variants via the at least one of the one or more statistics modules and the disease related variant information stored in the first data structure,
for at least one or more of the plurality of genomic variants that has at least one probability of disease that is greater than a threshold, obtain validation of the at least one of the plurality of genomic variants using the validation module;
in response to determining that validation of the at least one of the plurality of genomic variants is obtained, create a report via the reporting module, wherein the report comprises at least:
a disease and the likelihood of the disease, wherein the likelihood of disease is determined based at least in part on the one or more statistics modules and the disease related variant information stored in the first data structure.

9. The non-transitory computer-readable storage medium of claim 8, wherein the computer system is further configured to:
receive updated disease-related variant information;
in response to receiving updated disease-related variant information, automatically update the first data structure.

10. The non-transitory computer-readable storage medium of claim 8, wherein the one or more statistics modules comprises a rare disease statistics module and a common disease statistics module.

11. The non-transitory computer-readable storage medium of claim 10, wherein the rare disease statistics module is configured to apply a Fisher's exact test to calculate a likelihood of rare disease based on at least a variant.

12. The non-transitory computer-readable storage medium of claim 10, wherein the rare disease statistics module is configured to determine a likelihood of sequencing error.

13. The non-transitory computer-readable storage medium of claim 10, wherein the common disease statistics module is configured to apply a Fisher's exact test to calculate a likelihood of common disease based on at least a variant.

14. The non-transitory computer-readable storage medium of claim 8, wherein the report further comprises whether a variant is validated.

15. A computer implemented method for genomic variant analysis, the computer-implemented method comprising:
receiving and extracting disease related variant information;
storing the disease related variant information in a first data structure;
for each of a plurality of genomic sequences associated with a person, identifying a plurality of genomic variants via the variant analysis module;
storing the plurality of genomic variants in a second data structure;
determining one or more probability of disease associated with at least one or more of the plurality of genomic variants via the at least one of the one or more statistics modules and the disease related variant information stored in the first data structure,
for at least one or more of the plurality of genomic variants that has at least one probability of disease that is greater than a threshold, obtaining validation of the at least one of the plurality of genomic variants using the validation module;
in response to determining that validation of the at least one of the plurality of genomic variants is obtained, creating a report via the reporting module, wherein the report comprises at least:
a disease and the likelihood of the disease, wherein the likelihood of disease is determined based at least in part on the one or more statistics modules and the disease related variant information stored in the first data structure.

16. The computer-implemented method of claim 15, wherein the computer system is further configured to:
receive updated disease-related variant information;
in response to receiving updated disease-related variant information, automatically update the first data structure.

17. The computer-implemented method of claim 15, wherein the one or more statistics modules comprises a rare disease statistics module and a common disease statistics module.

18. The computer-implemented method of claim 17, wherein the rare disease statistics module is configured to apply a Fisher's exact test to calculate a likelihood of rare disease based on at least a variant.

19. The computer-implemented method of claim 17, wherein the rare disease statistics module is configured to determine a likelihood of sequencing error.

20. The computer-implemented method of claim 17, wherein the common disease statistics module is configured to apply a Fisher's exact test to calculate a likelihood of common disease based on at least a variant.

21. The computer-implemented method of claim 15, wherein the report further comprises whether a variant is validated.
